(19) United States
(12) Patent Application Publication
(10) Pub. No.: US 2013/0274435 A1
(43) Pub. Date: Oct. 17, 2013

(54) POLYMER POWDER WITH MODIFIED MELTING BEHAVIOUR

(71) Applicants: Wolfgang DIEKMANN, Waltrop (DE); Franz-Erich Baumann, Duelmen (DE); Maik Grebe, Bochum (DE)

(72) Inventors: Wolfgang DIEKMANN, Waltrop (DE); Franz-Erich Baumann, Duelmen (DE); Maik Grebe, Bochum (DE)

(21) Appl. No.: 13/859,896

(22) Filed: Apr. 10, 2013

(30) Foreign Application Priority Data
Apr. 11, 2012 (DE) 10 2012 205 908.3

(51) Int. Cl. C08G 69/26; C08G 69/28; B29C 67/00

(52) U.S. Cl. CPC C08G 69/26; B29C 67/0077; C08G 69/28
USPC 528/335; 264/250

(57) ABSTRACT

The present invention provides precipitated polymer powders based on a polyamide of the AABB type, obtained by the reprecipitation of the polyamides by at least partial dissolution followed by continuous cooling of the solution to below the precipitation temperature. The polyamides are prepared by polycondensation of diamines with dicarboxylic acids. The precipitated polyamides obtained are used in layer-by-layer shaping processes such as selective laser sintering.

### CROSS REFERENCE TO RELATED APPLICATIONS

This application claims priority to German Application No. 102012205908.3, filed Apr. 11, 2012, the disclosure of which is incorporated herein by reference in its entirety.

### BACKGROUND OF THE INVENTION

The present invention relates to precipitated polymer powders based on a polyamide of the AABB type, produced by polycondensation of diamines with dicarboxylic acids, to processes for production thereof, to processes for layer-by-layer production of three-dimensional objects, to the use of this powder in shaping processes for layer-by-layer production of three-dimensional objects, and to three-dimensional objects (mouldings) produced by a layer-by-layer process, with which regions of a powder layer are melted selectively, using this powder.

The rapid provision of prototypes is a problem which has frequently been presented in recent times. Particularly suitable processes are those which work on the basis of pulverulent materials, and in which the desired structures are produced layer by layer, by selective melting and solidification. It is possible to dispense with support constructions for overhangs and undercuts, since the powder bed surrounding the molten regions gives adequate support. There is likewise no finishing to remove supports. The processes are also suitable for the production of short runs.

A process of particularly good suitability for the purpose of rapid prototyping is selective laser sintering (SLS). In this process, polymer powders in a chamber are exposed selectively and briefly to a laser beam, which melts the powder particles that are hit by the laser beam. The molten particles coalesce and rapidly solidify again to form a solid material. Repeated exposure of layers which have always been newly applied can produce three-dimensional bodies in a simple and rapid manner by this process.

The process of laser sintering (rapid prototyping) for production of mouldings from pulverulent powders is described in detail in U.S. Pat. No. 6,136,948 and WO 96/06881. A multitude of polymers and copolymers is claimed for this application, including, for example, polyacetate, polypropylene, polyethylene, ionomers and polyamides.

Other processes of good suitability are the SIB (selective inhibition of binding) process as described in WO 01/38061, or a process as described in EP 1 015 214. Both processes work with infrared heating over the full area to melt the powder. The selectivity of melting in the former process is achieved by the application of an inhibitor, and in the second process by means of a mask. A further process is described in DE 103 11 438. In this process, the energy required for melting is introduced by means of a microwave generator and selectivity is achieved by application of a susceptor.

For the rapid prototyping or rapid manufacturing processes (RP or RM processes) mentioned, it is possible to use pulverulent substrates, especially polymers, preferably selected from polyester, polyvinyl chloride, polyacetal, polypropylene, polyethylene, polystyrene, polycarbonate, poly(N-methylmethacrylimide) (PMMI), polymethylmethacrylate (PMMA), ionomer, polyamide or mixtures thereof.

WO 95/11006 describes a polymer powder which is suitable for laser sintering and which, in the determination of the melting behaviour by dynamic differential calorimetry (differential scanning calorimetry, DSC) at a scanning rate of 10-20° C./min, does not exhibit any overlap of the melting and recrystallization peaks, has a degree of crystallinity likewise determined by DSC of 10-90%, has a number-average molecular weight Mn of 30 000-500 000, and has a quotient Mw/Mn in the range from 1 to 5.

DE 197 47 309 describes the use of a nylon-12 powder with an elevated melting peak and elevated enthalpy of fusion, this being obtained by reprecipitation of a polyamide prepared previously by ring opening and subsequent polycondensation of laurolactam. This is a polyamide of the AB type. However, the heat distortion resistance of the mouldings formed therefrom by a sintering process is not significantly greater than that of PA12 injection mouldings.

The powders which are based on AABB polyamides and are obtainable according to DE 102004020453 allow the production of mouldings of high heat distortion resistance; the use thereof generally encounters problems due to the melting characteristics, which are shown as a double peak in the DSC thermogram.

WO 2011/124278 describes a polymer powder which enables the production of very tough mouldings with elevated heat distortion resistance, these being usable in all layer-by-layer processing methods. In the case of use of, for example, AABB polyamide powders produced by grinding, laser sintering is affected by problems in terms of compliance with dimensional tolerance, precision of detail, surface quality, and in the course of processing in laser sintering. The processing problems are manifested, for example, in poor powder application, the excessively small or entirely lacking processing window or processing temperature range, heavy fuming or heavy outgassing, or by soiling of the equipment and the difficulties which result from this in conducting the process.

In general terms, there is an increasing level of new demands that the mechanical properties of the sintered parts should as far as possible approach those of injection mouldings; more particularly, the toughness of the sintered parts made from prior art powders is as yet unsatisfactory. Ever higher demands are also being made on heat distortion resistance. The powders which are based on AABB polyamides and are obtainable according to DE 102004020453 allow the production of mouldings of high heat distortion resistance, but the toughness thereof is inadequate.

It was therefore an object of the present invention to provide a polymer powder based on AABB polyamides, which enables the production of mouldings having very good compliance with dimensional tolerance and trueness of detail, with good surfaces and mechanical properties matched to the requirements, these being usable in all layer-by-layer processing methods.

### SUMMARY OF THE INVENTION

This and other objects have been achieved by the present invention, the first embodiment of which includes a polyamide polymer powder, comprising: an of the AABB type polyamide; wherein the polyamide polymer powder is obtained by a process, comprising: polycondensation of a diamine and a dicarboxylic acid to obtain an AABB type polyamide; at least partial dissolution of the AABB type polyamide in a solvent to form an at least partial solution; and continuous cooling of the at least partial solution to below a precipitation temperature of the AABB type polyamide, to reprecipitate the AABB type polyamide.

In another embodiment, the polyamide powder of the present invention exhibits a single endothermic maximum attributed to a melting process in a thermodiagram of the powder, thus indicating a unitary melting point of the polyamide powder.

In another embodiment, the solvent for the reprecipitation is an alcohol and in a further preferred embodiment, the reprecipitation is conducted under pressure.

In a further embodiment the present invention includes process for producing a polyamide polymer powder, comprising: polycondensation of a diamine and a dicarboxylic acid to obtain an AABB type polyamide; at least partial dissolution of the AABB type polyamide in a solvent; and continuous cooling of the at least partial solution to below a precipitation temperature of the AABB type polyamide to reprecipitate the AABB type polyamide. In a highly preferred embodiment the AABB type polyamide is completely dissolved in the solvent.

In an additional embodiment, the present invention includes a process for layer-by-layer production of a three-dimensional object, comprising: selectively melting and solidifying of at least one polyamide polymer powder of the present invention.

### DETAILED DESCRIPTION OF THE INVENTION

It has now been found that, surprisingly, polymer powders based on AABB polyamides having specified melting behaviour are of particularly good suitability for laser sintering processes.

The present invention therefore firstly provides polymer powders based on polyamides of the AABB type, obtained by the reprecipitation of polyamides obtained by polycondensation of diamines and dicarboxylic acids, by at least partial dissolution of the polyamides followed by continuous cooling of the solution to below the precipitation temperature. The polymer powders obtained according to the present invention have a unitary melting point determined by DSC. Preferably, the polyamides are dissolved completely, complete dissolution being understood to mean a solution which is at least visually clear. The melting point may also be referred to as the crystal melting point.

The term “unitary” according to the present invention is understood to mean melting points which, in the thermodiagram (plot of temperature against heat flux), exhibit only a single endothermic maximum (a single peak) which can be attributed to the melting process.

The at least partial dissolution of the polyamide may be effected at a dissolution temperature which may be determined by the person skilled in the art by a few tests. Subsequently, continuous cooling is effected below the precipitation temperature, as a result of which the precipitated polyamide is obtained.

Conventionally, fine powders are at least partly dissolved at a dissolution temperature. Subsequently, cooling is effected to a temperature at which the first nuclei of the powder form (nucleation temperature). Only then is the temperature lowered further, at least to the precipitation temperature. The additional step of at first remaining at a nucleation temperature where there is not complete precipitation does not result in conduction of continuous cooling in the sense of the invention. Instead, what is undertaken is a kind of two-stage precipitation. The powder obtained has at least two melting points and hence does not have a unitary melting point.

In the case of use of the polymer powders according to the present invention, the aforementioned problems may be avoided, and they additionally have mechanical characteristics which meet the demands. Compared to polymer powders conventionally known, for example according to DE 197 47 309 or else DE 102004020453, it may be possible in accordance with the present invention, according to the AABB type used, for example, for elongation at break to be increased, or for modulus of elasticity to be increased or reduced.

Polyamides of the AABB type in the context of the present invention are understood to mean those polyamides based on diamines and dicarboxylic acids. These are especially homopolymers having the general formula:

—(NH—(CH₂)ₓ—NH—CO—(CH)_{y}—CO)_{n/2}—

where n=20-200 and where x, y=2 to 20.

The AABB polyamides of the present invention contain at most small proportions of AB polyamides. Small proportions of AB polyamides are preferably not more than 5% by weight of AB polyamides, more preferably not more than 2% by weight, especially preferably not more than 1% by weight, very especially preferably not more than 0.5% by weight and especially 0% by weight of AB polyamides, based in each case on the total weight of AABB polyamides and AB polyamides.

The nomenclature of the polyamides is described in ISO 1874-1. More particularly, appendix A describes the definition and designation of aliphatic linear polyamides. Polyamides of the AABB type which are obtained from the polycondensation of diamines with dicarboxylic acids are designated with a brief description of the XY type where X and Y are each the chain length of the carbon chain of the monomer unit, i.e. X is the number of carbon atoms in the diamine and Y the number of carbon atoms in the dicarboxylic acid.

The polymer powders according to the present invention are based especially on polyamides of the AABB type, these preferably being based on diamines and dicarboxylic acids each having 4-18 carbon atoms, preferably 6 to 14 carbon atoms, in the respective monomer unit. The AABB polyamide may be entirely linear or lightly branched. “Lightly branched” means that one monomer unit may have one to three methyl or ethyl groups. The AABB polyamide may preferably be based on aliphatic linear monomers. The diamines may preferably be selected from the group comprising decanediamine (x=10), undecanediamine (x=11) or 1,12-diaminododecane (x=12). The dicarboxylic acids are preferably selected from the group comprising sebacic acid (decanedioic acid (y=8), dodecanedioic acid (y=10), brassylic acid (y=11) and tetradecanedioic acid (y=12), where y indicates the number of carbon atoms between the two terminal carboxyl groups. Particular preference is given to dicarboxylic acids where y=10 or y=11 according to the abovementioned formula.

Said diamines and dicarboxylic acids may be used in any combination with one another. More particularly, the polyamides of the AABB type may preferably include PA610, PA612, PA613, PA618, PA106, PA1010, PA1012, PA1018, PA1212, PA1218 and PA1013, particular preference being given to those of the 6,13, 6,18, 10,13 and 12,18 types.

In addition, the polyamide of the AABB type may have an excess of acid end groups, an equal distribution or a deficiency of acid end groups compared to the amino end groups. Particular preference may be given to a balanced ratio between acid and amino end groups. Preference may further be given to an acid excess with a molar ratio of acid end groups to amino end groups of 1.2:1 to 5:1. Preference may likewise be given to an excess of the amino end groups with a ratio of amine to acid of 1.2:1 to 5:1. The end group ratios may be established in a simple manner known to those skilled in the art. For example, in the case of polycondensation, specific regulators conventionally known to one of skill in the art may be added. Examples of corresponding regulators include excesses of the above-defined diamines or of the above-defined dicarboxylic acids.

It may also be possible to use other diamines such as linear diamines having 6-14 carbon atoms, cycloaliphatic diamines such as bis(p-aminocyclohexyl)methane or isophoronediamine, linear dicarboxylic acids having 6-18 carbon atoms, aromatic dicarboxylic acids such as terephthalic acid or isophthalic acid, naphthalenedicarboxylic acids, aliphatic monoamines such as laurylamine or triacetonediamine, or aliphatic monocarboxylic acids having 2-22 carbon atoms such as acetic acid, lauric acid, myristic acid, palmitic acid, stearic acid, oleic acid or erucic acid as regulators.

Suitable polyamides of the present invention may have a number-average molecular weight of 8000 to 50 000 g/mol, measured by gel permeation chromatography against a styrene standard.

An essential criterion for the polymer powders according to the present invention is that they have a unitary melting point determined by DSC, i.e. only a single melting point is measured for the inventive powders in DSC, whereas this is not the case for conventionally known powders. The DSC measurement is conducted according to DIN 53765 at a heating rate of 20 K/min.

The solution viscosity of the polymer powders according to the present invention as determined in 0.5% m-cresol solution to DIN 53727, is preferably 1.4 to 2.1, more preferably 1.5 to 1.9 and most preferably between 1.6 and 1.7.

The polyamide polymer powder of the present invention preferably has a mean particle size (d50) of 10 to 250 μm, preferably of 25 to 150 μm and more preferably of 40 to 125 μm. The particle size is determined by a Malvern Mastersizer 2000, dry measurement, 20-40 g of powder, by a Scirocco dry dispersion unit. The feed rate in a vibrating channel is 70%, the dispersion air pressure 3 bar. The analysis time of the sample is 5 seconds (5000 individual measurements); the refractive index and blue light value are defined as 1.52; the evaluation is effected using Mie theory.

The polymer powder according to the present invention additionally preferably has a bulk density between 300 and 700 g/l, preferably between 400 and 600 g/l, determined to DIN EN ISO 60.

In addition, the polymer powder according to the present invention preferably has BET surface areas between 1 and 15 m²/g, more preferably between 2 and 10 m²/g and most preferably between 2.5 and 7 m²/g, measured with nitrogen gas to DIN 9277 (volumetric method).

The polymer powders according to the present invention may be obtained by reprecipitation of AABB polyamides. Accordingly, the present invention further provides a process for producing polymer powders based on polyamides of the AABB type, comprising the reprecipitation of polyamides of the AABB type obtained by polycondensation of diamines and dicarboxylic acids (polymer process). The polyamides of the AABB type are first dissolved at least partly, preferably completely dissolved, and then brought by continuous cooling of the solution (without interruption) to below the precipitation temperature. Thus, the reprecipitation may provide polymer powders which are homogeneously meltable powders and may be processed to three-dimensional objects (mouldings) with high heat distortion resistance.

At the same time, the reprecipitated polymer powder according to the present invention has a unitary melting point determined by DSC. This may be achieved by reprecipitation and differs from, for example, corresponding melting points typical of granular materials, the melting points of the reprecipitated powders preferably being higher than the melting temperatures for the granular materials.

In the polymer process according to the invention, the AABB polyamides are reprecipitated. The reprecipitation is preferably effected from an alcoholic solution. In addition, it may be preferable to perform the reprecipitation under pressure. In a particularly preferred embodiment of the invention, the reprecipitation may be effected from alcoholic solution under pressure, as described, for example, in DE-A 3510689, DE 29 06 647 B1 or DE 19708146. In principle, suitable alcohols as solvents in reprecipitation are all of those known to those skilled in the art, preference being given to monoalcohols having 1 to 8 carbon atoms, more preferably having 1 to 4 carbon atoms, and very particular preference to ethanol as the solvent. The pressure is preferably in the range from 4 to 16 and more preferably in the range from 8 to 12 bar.

The AABB polyamides used may be present in any desired form; especially preferably, corresponding granular materials are used. For instance, suitable starting granular materials are sold commercially, for example by Evonik-Industries AG, Marl, Germany (e.g. nylon-6,12, trade name Vestamid D series) or by EMS Chemie, Donat, Switzerland (e.g. Technyl D, nylon-6,10).

The pressure typically arises as a result of the vapour pressure of the solvent in a closed system. Customary pressures are 1 to 15 bar.

For performance of the reprecipitation, the polyamides of the AABB type obtained by polycondensation from diamines and dicarboxylic acids may at least partly be dissolved in the solvent in a first step, and then precipitated from the solution in a subsequent step. The polyamides of the AABB type used for reprecipitation may preferably be dissolved in the solvent in a proportion of at least 5% by weight, preferably at least 10% by weight, more preferably at least 15% by weight (based on the total weight of the solution). The dissolution temperatures in the first step may be in the range of 120-190° C., preferably of 140-175° C.

The solutions obtained are then cooled in the second step of the reprecipitation at cooling rates in the range of 0.1-2.0° K./min, preferably in the range of 0.4-1.0° K./min. The precipitation temperatures of the polymer powders according to the present invention may be in the range of 100-150° C., preferably in the range of 105-135° C. In the specific individual case, the dissolution and precipitation conditions favourable for the respective polyamide mixture can be determined by manual tests. The polyamide concentrations (polyamide contents) which are to be chosen in the solutions are 5-30% by weight based on the total weight of the solution, preferably 10-25% by weight, more preferably 13-22% by weight. The dissolution temperatures required for achievement of a visually clear polyamide solution can be determined by preliminary tests.

The reprecipitation process according to the present invention provides polymer powders of polyamides of the AABB type, which feature a unitary melting point determined by means of DSC. In addition, the enthalpy of fusion of the inventive polymer powders may be 10% higher, preferably 25% higher and more preferably 40% higher than in the starting material used, i.e. of the polyamide of the AABB type used prior to reprecipitation. There optionally may follow a protective sieving operation and further classification or cold grinding. The person skilled in the art can easily find the conditions through exploratory preliminary tests.

The enthalpy of fusion is determined by means of DSC analogously to the standard already mentioned.

To obtain polyamide powder with relatively narrow particle distribution, it is possible that the actual precipitation is preceded by a nucleation phase according to DE 19708949, in which the polyamide solution remains visually clear and no exothermic crystallization is observed. For this purpose, the alcoholic solution is stirred isothermally at 2° K. to 20° K., preferably 5° K. to 15° K., above the later precipitation temperature for the aforementioned period, and the temperature is then lowered at the above cooling rates to the precipitation temperature, which should then be kept very substantially constant. Suitable units may be stirred tanks, preference being given to using paddle stirrers. However, it may be possible without difficulty to perform the precipitation in other pressure-resistant apparatuses and/or to use other stirrer equipment. For removal of any residual monomers or oligomers which are troublesome in the later processing, it may be possible to subject one or more of the polyamides to be reprecipitated to an extraction beforehand.

The above-described features of the polymer process according to the invention apply analogously to the polymer obtained by the process described above.

The polymer powders according to the present invention may be particularly suitable for layer-by-layer production of three-dimensional objects. Thus, the present invention further provides a process for layer-by-layer production of three-dimensional objects, using polymer powders according to the present invention (layer process). In the course of the layer process, the polymer powder according to the present invention is applied and regions of the respective layer are melted selectively. Subsequently, a further layer of the polymer powder according to the present invention can be applied and can again likewise be melted selectively. In this way, a three-dimensional object is produced in accordance with the invention by layer-by-layer buildup. After cooling and solidification of the regions which have previously been applied in molten form layer by layer, the three-dimensional object obtained, also called moulding hereinafter, can be removed from the powder bed.

The polymer powders according to the present invention have the advantage that they may be used, by processes which work layer by layer, in which regions of the respective layer are melted selectively, to produce mouldings having elevated heat distortion resistance, higher toughness values, better dimensional accuracy and better surface quality compared to mouldings produced from conventional polyamide powders.

In principle, the polymer powders according to the present invention may be suitable for all rapid prototyping or rapid manufacturing processes (RP or RM processes) known to those skilled in the art. In principle, all kinds of radiation are suitable for this purpose, especially particle beams, photon radiation and/or electromagnetic radiation, it being possible to use combinations of the radiation types mentioned in any sequence or else simultaneously. Selectivity may be achieved, for example, by use of masks, application of inhibitors, absorbers, susceptors, or else by focusing of the radiation, as conventionally known.

The layer process may be performed by known methods such as SIB or SLS, preferably SLS.

Advantageously, the energy is introduced by means of electromagnetic radiation. The electromagnetic radiation may be coherent or noncoherent and/or monochromatic or nonmonochromatic and/or directed or undirected. Visible light is a special case of electromagnetic radiation, which emits a wavelength within the range visible to the human eye, i.e. between 380 and 780 nm. The electromagnetic radiation may be within the region of visible light, in the near infrared, mid infrared or far infrared region, or else in the ultraviolet region (10 to 380 nm), preferably in the visible region or in the near infrared region. The energy is transferred via convection and via radiation, preference being given to the latter. The simplest case involves radiant heaters or lamps. Without any intention to restrict the invention thereto, these may be selected from incandescent lamps, halogen lamps, fluorescent lamps or high-pressure discharge lamps. The radiation source may therefore be an incandescent wire, for example with one or two turns, and the design may be an incandescent lamp or an incandescent halogen lamp; the spectrum of radiation emitted is more likely to extend into the infrared than into the ultraviolet region. The contents of the lamp may comprise various gases and vapours, halogens in the case of the incandescent halogen lamps, or else the lamp may contain a vacuum. A further embodiment is the use of gas discharges as the radiation source, for which high-pressure discharge and low-pressure discharge are known working principles. The gas discharge lamps are filled with a principal gas; this may be metal gases or noble gases, for example neon, xenon, argon, krypton, and mercury, also doped with, for example, iron or gallium, and vapours comprising mercury, metal halides, sodium, rare earths. According to the design, they are called high-pressure mercury vapour lamps, halogen-metal vapour lamps, high-pressure sodium vapour lamps, long-arc xenon lamps, low-pressure sodium vapour lamps, UV lamps, fluorescent lamps or fluorescent tubes. In addition, it is possible to use mixed light lamps in which an incandescent lamp is combined with a high-pressure mercury vapour lamp. The radiation source may also take the form of a solid-state discharge, in which case what are called luminescent sheets are involved (electroluminescent sheets). Mention should also be made of light-emitting diodes which work by the principle of electroluminescence with direct semiconductor junctions or indirect junctions with isoelectronic recombination sites. In order, for example, to convert UV radiation to visible light in low-pressure mercury vapour lamps, what are called luminophores are used. These are very pure crystals provided with exactly defined impurities (doping). Usually, the inorganic crystals are phosphates, silicates, tungstates, vanadates, which find use individually, but also in combination. If a radiant heater is used, it preferably emits in the near infrared or mid infrared range, the near infrared range (infrared A) encompassing a wavelength of 780 nm to 1400 nm and the mid infrared range (IR-B) a wavelength of 1400 nm to 3000 nm. The far infrared range (IR-C) having a wavelength of 3000 nm to 1 mm is also used, but it is necessary here to carefully match the substrate and the absorber whose use is then advantageous, since, in the case of use of polymers as the substrate, the substrate itself can absorb sufficient energy for sintering in the case of IR-C. This can be achieved by the suitable selection of substrate, or adjustment of the difference in the absorption between absorber-occupied regions and untreated regions. Preference is given, however, to the near infrared and mid infrared region. The radiant heater for the infrared region comprises short-wave IR radiators, for example halogen IR radiators, quartz tube radiators, and ceramic or metal tube radiators. The radiation sources may emit a wide spectrum in respect of wavelength, and the centre may be within the visible region, within the infrared region or within the ultraviolet region, or else emit rays with virtually discontinuous individual narrow wavelength ranges. One example is the low-pressure sodium vapour lamp which emits radiation almost exclusively within the range from 560 to 600 nm. The absorber and the radiation source used are preferably matched to one another. According to the radiation source, the power may be between 10 and 10 000 watts. Typical colour temperatures are between 800 and 10 000 K. The radiation source may be a point source, a linear source or an areal source. It is also possible to combine several radiation sources with one another. For better exploitation of the energy, reflectors or refractors may be used. In addition, it is possible to use slits in order to be able to better direct the radiation.

The process for layer-by-layer production of three-dimensional objects may preferably be a selective laser sintering process. Laser sintering processes are conventionally known and are based on the selective sintering of polymer particles, with brief exposure of layers of polymer particles to laser light, thus bonding the particles which were exposed to the laser light to one another. The successive sintering of layers of polymer particles produces three-dimensional objects. Details of the selective laser sintering process may be found in U.S. Pat. No. 6,136,948 and WO 96/06881. Suitable lasers for the preferred laser sintering processes may especially be CO₂ lasers. After all layers have been cooled, the inventive shaped body may be removed.

In the layer processes according to the present invention, the polymer powders according to the present invention may additionally comprise assistants and/or fillers and/or organic and/or inorganic pigments. Such assistants may, for example, be free-flow aids, for example precipitated and/or fumed silicas. Precipitated silicas are supplied, for example, under the AEROSIL® product name, with different specifications, by Evonik Industries AG. Preferably, the polymer powder used in accordance with the invention contains less than 3% by weight, preferably from 0.001 to 2% by weight and most preferably from 0.05 to 1% by weight of such assistants, based on the total weight of the polymers present. The fillers may, for example, be glass, metal or ceramic particles, for example glass beads, steel balls, metal grit or extraneous pigments, for example transition metal oxides. The pigments may be selected, for example, from titanium dioxide particles based on rutile or anatase, or carbon black particles.

The filler particles preferably have a smaller or about the same mean particle size as the particles of the polyamides. The mean particle size d₅₀ of the fillers should preferably exceed the mean particle size d₅₀ of the polyamides by not more than 20%, preferably by not more than 15% and most preferably by not more than 5%. The particle size may be limited particularly by the permissible overall height or layer thickness in the rapid prototyping/rapid manufacturing plant.

The polymer powder used in accordance with the invention may preferably contain less than 75% by weight, more preferably from 0.001 to 70% by weight, especially preferably from 0.05 to 50% by weight and most preferably from 0.5 to 25% by weight of such fillers, based on the total weight of the polyamides present.

In the case of exceedance of the specified upper limits for assistants and/or fillers, according to the filler or assistant used, there may be deterioration of the mechanical properties of the mouldings obtained.

It may be possible to mix conventional polymer powders with polymer powders according to the present invention to produce polymer powders having a further combination of surface properties. A process for production of mixtures is described, for example, in DE 34 41 708.

To improve the fusion profile in the course of production of the mouldings, a levelling agent, for example metal soaps, preferably alkali metal or alkaline earth metal salts of the parent alkanemonocarboxylic acids or dimer acids, may be added to polyamide powder. The metal soap particles may be incorporated into the polymer particles.

The metal soaps may be used in amounts of 0.01 to 30% by weight, preferably 0.5 to 15% by weight, based on the total weight of the polyamides present in the powder. Preferably, the metal soaps used are the sodium or calcium salts of the parent alkanemonocarboxylic acids of dimer acids. Examples of commercially available products are Licomont NaV 101 or Licomont CaV 102 from Clariant.

The mouldings produced from the powder according to the present invention may have mechanical properties matched to the requirements set for the moulding. The processability of the powder according to the present invention may also be comparable to that of conventional polyamide powders.

The invention further provides for the use of the powders according to the present invention for layer-by-layer production of three-dimensional objects or mouldings. The present invention likewise provides three-dimensional objects (mouldings) produced by the inventive layer process for layer-by-layer production of three-dimensional objects using polymer powders according to the present invention.

Even without further details, it is assumed that a person skilled in the art will be able to utilize the above description to the maximum degree. The preferred embodiments and examples should accordingly be regarded merely as descriptive disclosure which is not limiting in any way whatsoever.

Having generally described this invention, a further understanding can be obtained by reference to certain specific examples which are provided herein for purposes of illustration only, and are not intended to be limiting unless otherwise specified. Alternative embodiments of the present invention are obtainable in an analogous manner.

### EXAMPLES

In the context of the present invention, the following test methods were used:

| | | Test type/test |
|---|---|---|
| Variable tested | Unit | equipment/test parameter |
| Bulk density | g/cm³ | DIN EN ISO 60 |
| Particle size d50 | μm | Malvern Mastersizer 2000, dry |
| | | measurement, 20-40 g of powder metered |
| | | in by means of Scirocco dry dispersion |
| | | unit. Feed rate from vibrating |
| | | channel 70%, dispersion air |
| | | pressure 3 bar. Measurement |
| | | time for the sample 5 seconds (5000 |
| | | individual measurements), refractive index |
| | | and blue light value defined as 1.52. |
| | | Evaluation using Mie theory. |
| Particle size d10 | μm | Malvern Mastersizer 2000, for parameters |
| | | see particle size d50 |
| Particle size d90 | μm | Malvern Mastersizer 2000, for parameters |
| | | see particle size d50 |
| Proportion by mass | % | Malvern Mastersizer 2000, for parameters |
| of particle | | see particle size d50 |
| size < 10.48 μm | | |
| Free flow | s | DIN EN ISO 6186, method A, nozzle |
| | | outlet diameter 15 mm |
| Solution | — | ISO 307, Schott AVS Pro, solvent: acidic |
| viscosity | | m-cresol, volumetric method, double |
| | | determination, dissolution temperature |
| | | 100° C., dissolution time 2 h, polymer |
| | | concentration 5 g/l, |
| | | measurement temperature 25° C. |
| BET | m²/g | ISO 9277, Micromeritics TriStar 3000, gas |
| (spec. surface area) | | adsorption of nitrogen, discontinuous |
| | | volumetric method, 7 measurement points |
| | | at relative pressures P/P0 between approx. |
| | | 0.05 and approx. 0.20, calibration of dead |
| | | volume by means of He (99.996%), sample |
| | | preparation at 23° C. for 1 h + at 80° C. for |
| | | 16 h under reduced pressure, spec. surface |
| | | area based on the degassed sample, |
| | | evaluation effected by means of multipoint |
| | | determination |
| Melting point, | ° C. | DIN 53765 DSC 7 from Perkin Elmer, |
| 1^{st} heating | | heating/cooling rate 20 K/min |
| Recrystallization | ° C. | DIN 53765 DSC 7 from Perkin Elmer, |
| temperature | | heating/cooling rate 20 K/min |

| | |
|---|---|
| Material | Material is stored prior to processing/analysis at |
| conditioning | 23° C. and 50% air humidity for 24 h |

The test instrument used for the determination of melting and recrystallization temperature was the Perkin Elmer Diamond or DSC 7 system (DDLK principle). 6 to 8 mg of the sample were introduced into unpierced crucibles with the lid placed on. Nitrogen at a flow rate of 20 ml/min served as the purge gas. The sample was heated from −30° C. to 270° C. and the crystal melting point was determined. The enthalpy was determined via an evaluation of the linear connecting line according to said standard DIN 53765.

### Synthesis Example 1

### PA1010

For production of a PA 1010, a 2001 stirred autoclave was charged with the following feedstocks:
34.957 kg of 1,10-decanediamine (as 98.5% aqueous solution),
40.902 kg of sebacic acid and
8.6 g of a 50% aqueous solution of hypophosphorous acid (corresponding to 0.006% by weight) with
25.3 kg of demineralized water.

The feedstocks were melted in a nitrogen atmosphere and heated to approx. 220° C. in the closed autoclave while stirring, in the course of which an internal pressure of approx. 20 bar was established. This internal pressure was maintained for 2 hours; thereafter, the melt was heated further to 270° C. with continuous decompression to standard pressure and then kept at this temperature in a nitrogen stream for 1.5 hours. This was followed by decompression to atmospheric pressure within 3 hours and passage of nitrogen over the melt for a further 3 hours until the torque no longer showed any further rise in melt viscosity. Thereafter, the melt was discharged by a gear pump and granulated as a strand. The granules were dried at 80° C. under nitrogen for 24 hours.
Yield: 65 kg
The product has the following characteristics:
Crystal melting point Tₘ: 192° C. and 204° C.
Enthalpy of fusion: 78 J/g
Relative solution viscosity ηᵣₑₗ: 1.76

### Synthesis Example 2

### PA1012

Based on Example 1, the following feedstocks were reacted with one another:
34.689 kg of 1,10-decanediamine (98.7%),
46.289 kg of dodecanedioic acid and
9.2 g of a 50% aqueous solution of hypophosphorous acid (corresponding to 0.006% by weight) with
20.3 kg of demineralized water.
Yield: 73.6 kg
The product had the following characteristics:
Crystal melting point Tₘ: 181° C. (shoulder) and 191° C.
Enthalpy of fusion: 74 J/g
Relative solution viscosity ηᵣₑₗ: 1.72

### Synthesis Example 3

### PA1013

Based on Example 1, the following feedstocks were reacted with one another:
33.521 kg of 1,10-decanediamine (98.7%),
47.384 kg of brassylic acid and
9.5 g of a 50% aqueous solution of hypophosphorous acid (corresponding to 0.006% by weight) with
20.5 kg of demineralized water.
The product had the following characteristics:
Relative solution viscosity ηᵣₑₗ: 1.66 (load 1), 1.77 (load 2)
Crystal melting point Tₘ: 183° C. and 188° C.
Enthalpy of fusion: 71 J/g

### Synthesis Example 4

### PA1212

Based on Example 1, the following feedstocks were reacted with one another:
33.366 kg of 1,12-dodecanediamine (as a 97.5% aqueous solution),
37.807 kg of dodecanedioic acid and
8.1 g of a 50% aqueous solution of hypophosphorous acid (corresponding to 0.006% by weight) with
20.5 kg of demineralized water.
The product had the following characteristics:
Crystal melting point Tₘ: 180° C. and 187° C.
Enthalpy of fusion: 75 J/g
Relative solution viscosity ηᵣₑₗ: 1.81 (load 1), 1.73 (load 2)

### Synthesis Example 5

### PA613

Based on Example 1, the following feedstocks were reacted with one another:
3.395 kg of hexamethylenediamine (as a 71.2% aqueous solution),
48.866 kg of brassylic acid and
14.86 g of a 50% aqueous solution of hypophosphorous acid (corresponding to 0.006% by weight) with
16.6 kg of demineralized water.
The product had the following characteristics:
Crystal melting point Tₘ: 193° C. and 204° C.
Enthalpy of fusion: 88 J/g
Relative solution viscosity ηᵣₑₗ: 1.75

### Synthesis Example 6

### PA106

Based on Example 1, the following feedstocks were reacted with one another:
36.681 kg of 1,10-decanediamine (as a 98.7% aqueous solution),
30.276 kg of adipic acid and
12.76 g of a 50% aqueous solution of hypophosphorous acid (corresponding to 0.006% by weight) with
20.3 kg of demineralized water.
The product had the following characteristics:
Crystal melting point Tₘ: 216° C. and 237° C.
Enthalpy of fusion: 84 J/g
Relative solution viscosity ηᵣₑₗ: 1.85

### Example 1

### Reprecipitation of Nylon-12 (PA 12) (Comparative)

40 kg of unregulated PA 12 prepared by hydrolytic polymerization and having a relative solution viscosity of 1.62 and an end group content of 75 mmol/kg COOH and 69 mmol/kg NH₂ were brought to 145° C. in an 800 l stirred tank within 2.5 hours together with 2500 l of ethanol, denatured with 2-butanone and with water content 1%, and left at this temperature while stirring for 1 hour (dissolution temperature). Subsequently, the jacket temperature was reduced to 124° C. and the internal temperature was brought to 125° C. at the same stirrer speed at a cooling rate of 25 K/h with continuous distillative removal of the ethanol. From then on, the jacket temperature was kept 2 K-3 K below the internal temperature at the same cooling rate. The internal temperature was brought to 117° C. at the same cooling rate and then kept constant for 60 minutes (nucleation temperature). Thereafter, distillative removal continued at a cooling rate of 40 K/h and the internal temperature was thus brought to 111° C. (precipitation temperature). Precipitation set in at this temperature, recognizable by the evolution of heat. The distillation rate was increased to such an extent that the internal temperature did not rise above 111.3° C. After 25 minutes, the internal temperature fell, which indicated the end of precipitation. By further distillative removal and cooling via the jacket, the temperature of the suspension was brought to 45° C. and the suspension was then transferred to a paddle dryer. The ethanol was distilled off at 70° C./400 mbar and the residue was then dried at 20 mbar/86° C. for 3 hours. This gave precipitated PA 12 having a mean particle diameter of 55 μm. The bulk density was 435 g/l.

### Example 2

### Reprecipitation of PA 1010 (Comparative)

Based on Example 1, 40 kg of the PA 1010 specimen obtained in synthesis example 1 were reprecipitated; the precipitation conditions were set as follows:

| Dissolution temperature: | 155° | C., |
|---|---|---|
| nucleation temperature/time: | 128° C./60 min | |
| Precipitation temperature: | 120° | C., |
| precipitation time: | 1 | hour, |
| stirrer speed: | 90 | rpm |
| Crystal melting point Tₘ: | 192° C. and 206° C. | |
| Enthalpy of fusion: | 128 | J/g |
| Relative solution viscosity ηᵣₑₗ: | 1.69 | |
| Bulk density | 380 | g/l |
| BET: | 6.80 | m²/g |
| D(10%) = | 44 | μm |
| D(50%) = | 69 | μm |
| D(90%) = | 103 | μm |

### Example 3

### Reprecipitation of PA 1012 (Comparative)

In accordance with Example 1, 40 kg of the PA 1012 granule specimen obtained in synthesis example 2 were reprecipitated, except that the precipitation conditions according to Example 1 were modified as follows:

| Dissolution temperature: | 155° | C., |
|---|---|---|
| nucleation temperature: | 141° | C., |
| precipitation temperature: | 123° | C., |
| precipitation time: | 40 | minutes, |
| stirrer speed: | 110 | rpm |
| Crystal melting point Tₘ: | 191° C. and 202° C. | |
| Enthalpy of fusion: | 148 | J/g |
| Relative solution viscosity ηᵣₑₗ: | 1.69 | |
| Bulk density | 430 | g/l. |
| BET: | 3.90 | m²/g |
| D(10%) = | 34 | μm |
| D(50%) = | 65 | μm |
| D(90%) = | 94 | μm |

### Example 4

### Reprecipitation of PA 1212 (Comparative)

In accordance with Example 1, 40 kg of the PA 1212 granule specimen obtained in synthesis example 4 (load 1) were reprecipitated, except that the precipitation conditions were set as follows:

| Dissolution temperature: | 155° | C., |
|---|---|---|
| nucleation temperature: | 123° | C., |
| nucleation time: | 60 | min |
| Precipitation temperature: | 117° | C., |
| precipitation time: | 60 | minutes, |
| stirrer speed: | 110 | rpm |
| Bulk density | 392 | g/l. |
| BET: | 5.60 | m²/g |
| D(10%) = | 33 | μm |
| D(50%) = | 75 | μm |
| D(90%) = | 114 | μm |
| Crystal melting point Tₘ: | 187° C. and 194° C. | |
| Enthalpy of fusion: | 143 | J/g |

| | |
|---|---|
| Relative solution viscosity ηᵣₑₗ: | 1.79 |

### Example 5

### Reprecipitation of PA 1013 (Comparative)

In accordance with Example 1, 40 kg of the PA 1013 granule specimen obtained in synthesis example 3 (load 1) were reprecipitated, except that the precipitation conditions were set as follows:

| Dissolution temperature: | 145° | C., |
|---|---|---|
| nucleation temperature: | 113° | C., |
| nucleation time: | 60 | min |
| Precipitation temperature: | 102° | C., |
| precipitation time: | 60 | minutes, |
| stirrer speed: | 110 | rpm |
| Bulk density | 452 | g/l. |
| BET: | 4.40 | m²/g |
| D(10%) = | 25 | μm |
| D(50%) = | 59 | μm |
| D(90%) = | 94 | μm |
| Crystal melting point Tₘ: | 182° C. and 190° C. | |
| Enthalpy effusion: | 143 | J/g |

| | |
|---|---|
| Relative solution viscosity ηᵣₑₗ: | 1.62 |

### Example 6

### Reprecipitation of PA1010 (According to the Invention)

In accordance with Example 1, but without setting a nucleation temperature, 40 kg of the PA 1010 granule specimen as obtained in synthesis example 1 are reprecipitated.

| | | |
|---|---|---|
| Dissolution temperature: | 149° | C., |
| nucleation temperature: | | none, |
| nucleation time: | | none |
| Precipitation temperature: | 120° | C., |
| precipitation time: | 120 | minutes, |
| stirrer speed: | 90 | rpm |
| Bulk density: | 380 | g/l |
| BET: | 17.3 | m²/g |
| D(10%) = | 53 | μm |
| D(50%) = | 79 | μm |
| D(90%) = | 120 | μm |
| Crystal melting point Tₘ: | 209° | C. |
| Enthalpy of fusion: | 154 | J/g |

| | |
|---|---|
| Relative solution viscosity ηᵣₑₗ: | 1.74 |

### Example 7

### Reprecipitation of PA613 (According to the Invention)

In accordance with Example 1, but without setting a nucleation temperature, 40 kg of the PA 613 granule specimen obtained in synthesis example 5 were reprecipitated, except that the precipitation conditions were set as follows:

| | | |
|---|---|---|
| Dissolution temperature: | 156° | C., |
| nucleation temperature: | | none, |
| nucleation time: | | none |
| Precipitation temperature: | 123° | C., |
| precipitation time: | 120 | minutes, |
| stirrer speed: | 150 | rpm |
| Bulk density: | 464 | g/l |
| BET: | 5.3 | m²/g |
| D(10%) = | 47 | μm |
| D(50%) = | 69 | μm |
| D(90%) = | 101 | μm |
| Crystal melting point Tₘ: | 210° | C. |
| Enthalpy of fusion: | 137 | J/g |

| | |
|---|---|
| Relative solution viscosity ηᵣₑₗ: | 1.70 |

### Example 8

### Reprecipitation of PA106 (According to the Invention)

In accordance with Example 1, but without setting a nucleation temperature, 40 kg of the PA 106 granule specimen obtained in synthesis example 6 were reprecipitated, except that the precipitation conditions were modified as follows:

| | | |
|---|---|---|
| Dissolution temperature: | 165° | C., |
| nucleation temperature: | | none, |
| nucleation time: | | none |
| Precipitation temperature: | 142° | C., |
| precipitation time: | 150 | minutes, |
| stirrer speed: | 150 | rpm |
| Bulk density: | 402 | g/l. |
| BET: | 7.9 | m²/g |
| D(10%) = | 48 | μm |
| D(50%) = | 69 | μm |
| D(90%) = | 101 | μm |
| Crystal melting point Tₘ: | 242° | C. |
| Enthalpy of fusion: | 147 | J/g |

| | |
|---|---|
| Relative solution viscosity ηᵣₑₗ: | 1.84 |

### Example 9

### Reprecipitation of PA1013 (According to the Invention)

In accordance with Example 1, but without setting a nucleation temperature, 40 kg of the PA 1013 granule specimen obtained in synthesis example 3 (load 2) were reprecipitated, except that the precipitation conditions were set as follows:

| | | |
|---|---|---|
| Dissolution temperature: | 145° | C., |
| nucleation temperature: | | none, |
| nucleation time: | | none |
| Precipitation temperature: | 102° | C., |
| precipitation time: | 150 | minutes, |
| stirrer speed: | 190 | rpm |
| Bulk density: | 482 | g/l. |
| BET: | 2.0 | m²/g |
| D(10%) = | 32 | μm |
| D(50%) = | 45 | μm |
| D(90%) = | 64 | μm |
| Crystal melting point Tₘ: | 182° | C., |
| Enthalpy of fusion: | 116 | J/g |

| | |
|---|---|
| Relative solution viscosity ηᵣₑₗ: | 1.76 |

### Example 10

### Reprecipitation of PA1212 (According to the Invention)

In accordance with Example 1, but without setting a nucleation temperature, 40 kg of the PA 1212 granule specimen obtained in synthesis example 4 (load 2) were reprecipitated, except that the precipitation conditions were set as follows:

| | | |
|---|---|---|
| Dissolution temperature: | 155° | C., |
| nucleation temperature: | | none, |
| nucleation time: | | none |
| Precipitation temperature: | 115° | C., |
| precipitation time: | 120 | minutes, |
| stirrer speed: | 120 | rpm |
| Bulk density: | 392 | g/l. |
| BET: | 1.40 | m²/g |
| D(10%) = | 25 | μm |
| D(50%) = | 51 | μm |
| D(90%) = | 88 | μm |
| Crystal melting point Tₘ: | 183° | C. |
| Enthalpy of fusion: | 128 | J/g |

| | |
|---|---|
| Relative solution viscosity ηᵣₑₗ: | 1.64 |

1. A polyamide polymer powder, comprising:
an AABB type polyamide;
wherein the polyamide polymer powder is obtained by a process, comprising:
polycondensation of a diamine and a dicarboxylic acid to obtain an AABB type polyamide;
at least partial dissolution of the AABB type polyamide in a solvent to form an at least partial solution; and
continuous cooling of the at least partial solution to below a precipitation temperature of the AABB type polyamide, to reprecipitate the AABB type polyamide.

2. The polyamide polymer powder according to claim 1, wherein a thermodiagram of the powder exhibits a single endothermic maximum attributed to a melting process, thus indicating a unitary melting point of the polyamide powder.

3. The polyamide polymer powder according to claim 1, wherein the solvent is an alcohol.

4. The polyamide polymer powder according to claim 1, wherein the reprecipitation is conducted under pressure.

5. The polyamide polymer powder according to claim 1,wherein the reprecipitation comprises cooling the solution to below the precipitation temperature without interruption.

6. The polyamide polymer powder according to the diamine and dicarboxylic acid each independently comprise 4-18 carbon atoms.

7. The polyamide polymer powder according to claim 6, wherein the diamine is selected from the group consisting of decanediamine, undecanediamine and 1,12-diaminododecane.

8. The polyamide polymer powder according to claim 6, wherein the dicarboxylic acid is selected from the group consisting of sebacic acid, dodecanedioic acid, brassylic acid and tetradecanedioic acid.

9. The polyamide polymer powder according to claim 1, wherein polyamide is at least one member selected from the group consisting of PA610, PA612, PA613, PA618, PA106, PA1010, PA1012, PA1013, PA1018, PA1212, PA1218 and PA1013.

10. A process for producing a polyamide polymer powder, comprising:
polycondensation of a diamine and a dicarboxylic acid to obtain an AABB type polyamide;
at least partial dissolution of the AABB type polyamide in a solvent; and
continuous cooling of the at least partial solution to below a precipitation temperature of the AABB type polyamide to reprecipitate the AABB type polyamide.

11. The process according to claim 10, wherein the solvent is an alcohol.

12. The process according to claim 11, wherein the AABB type polyamide is completely dissolved in the alcohol solvent.

13. The process according to claim 11, wherein the at least partial dissolution and reprecipitation is conducted under pressure.

14. A process for layer-by-layer production of a three-dimensional object, comprising: selectively melting and solidifying of at least one polyamide polymer powder according to claim 1.

15. The process according to claim 14, wherein the selective melting and solidifying comprises a laser sintering or a selective inhibition of binding.

16. A three-dimensional object or molding, obtained by the method according to claim 14.
